(19) United States
(12) Patent Application Publication
(10) Pub. No.: US 2016/0370470 A1
(43) Pub. Date: Dec. 22, 2016

(54) ON-BOARD UNIT AND SPOOFING DETECTING METHOD

(71) Applicant: MITSUBISHI HEAVY INDUSTRIES, LTD., Tokyo (JP)

(72) Inventors: Yoshihiro MABUCHI, Tokyo (JP); Masato IEHARA, Tokyo (JP); Kenji FUJITA, Tokyo (JP); Taizo YAMAGUCHI, Tokyo (JP)

(21) Appl. No.: 14/901,723

(22) PCT Filed: Jul. 2, 2014
(86) PCT No.: PCT/JP2014/067637

§ 371 Date: Dec. 29, 2015

(30) Foreign Application Priority Data
Jul. 3, 2013 (JP) 2013-139994

(51) Int. Cl. G01S 19/21; G07B 15/06

(52) U.S. Cl. CPC G01S 19/215; G07B 15/063

(57) ABSTRACT

An on-board unit includes a satellite information acquiring section and a processing section. The satellite information acquiring section is configured to output first time data showing current time based on a satellite signal received from an artificial satellite. The processing section is configured to acquire second time data showing current time based on a radio signal which is different from the satellite signal, and to detect a spoofing based on a difference of a time shown by the first time data and a time shown by the second time data.

### RELATED APPLICATIONS

The present application is a National Phase of International Application Number PCT/JP2014/067637, filed Jul. 2, 2014, which claims priority of Japanese Application No. 2013-139994, filed Jul. 3, 2013.

### TECHNICAL FIELD

The present invention relates to an on-board unit that uses GNSS (Global Navigation Satellite System).

### BACKGROUND ART

A satellite positioning system is used that estimates the position of a vehicle and so on on the ground by using signals generated from artificial satellites. As such a technique, GNSS (Global Navigation Satellite Systems) such as GPS (Global Positioning System), GLONASS, and Galileo system are known.

By using the satellite positioning system, for example, charging processing to the vehicle which runs on an area set as a toll highway can be carried out based on the positioning result of the vehicle by the artificial satellites.

### CITATION LIST

### [Patent Literature 1]: JP 2008-510138A

### [Patent Literature 2]: Singaporean Patent Publication 171571A

### SUMMARY OF THE INVENTION

In the satellite positioning system, a technique called a spoofing is known in which the estimated position is made to be mistaken as a position different from an actual position by camouflaging positioning signals transmitted from the artificial satellites. A technique is demanded that makes it possible to detect the spoofing, in order to carry out the charging process to the vehicle on the toll highway properly. Patent Literatures 1 and 2 are examples of the technique to cope with the spoofing.

In an aspect of the present invention, an on-board unit includes a positioning section which outputs position data showing a current position of a vehicle and first time data showing current time based on a satellite signal received from an artificial satellite; and a processing section which acquires second time data showing current time by a radio signal which is different from the satellite signal, and detects a spoofing based on a difference between a time shown by the first time data and a time shown by the second time data.

In an aspect of the present invention, a spoofing detecting method includes: outputting position data showing a current position of a vehicle and first time data showing current time based on a satellite signal received from an artificial satellite; acquiring second time data showing current time by a radio signal which is different from the satellite signal; and detecting a spoofing based on a difference between a time shown by the first time data and a time shown by the second time data.

According to the present invention, a technique which makes the spoofing detection possible is provided.

### BRIEF DESCRIPTION OF THE DRAWINGS

FIG. 1 is a diagram showing a configuration of a satellite positioning system.

FIG. 2 is a diagram showing a configuration of an on-board unit.

FIG. 3 is a diagram showing a configuration of a spoofing detecting section.

FIG. 4 is a diagram showing an operation of the on-board unit.

FIG. 5 is a diagram showing a configuration of the satellite positioning system.

FIG. 6 is a diagram showing a configuration of the on-board unit.

FIG. 7 is a diagram showing a configuration of the satellite positioning system.

FIG. 8 is a diagram showing a configuration of the on-board unit.

FIG. 9 is a diagram showing a configuration of the spoofing detecting section.

FIG. 10 is a diagram showing an operation of the on-board unit.

FIG. 11 is a diagram showing an operation of the on-board unit.

FIG. 12 is a diagram showing an operation of the on-board unit.

FIG. 13 is a diagram showing an operation of the on-board unit.

FIG. 14 is a diagram showing a base station ID table.

### DESCRIPTION OF THE EMBODIMENTS

### First Embodiment

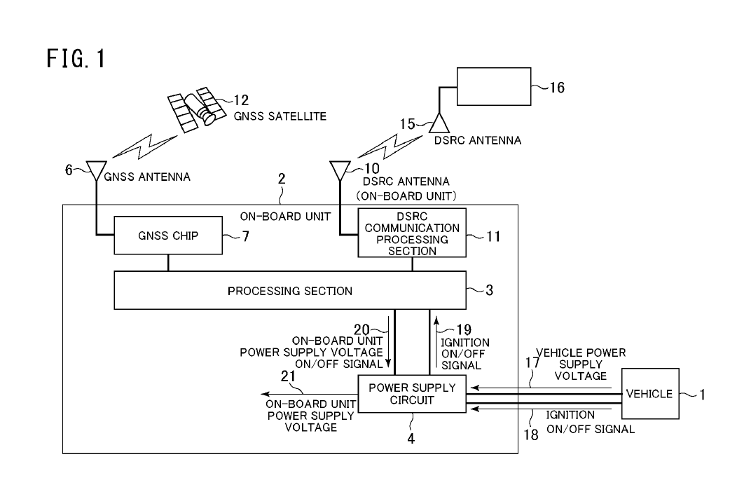

Hereinafter, embodiments of the present invention will be described with reference to the attached drawings. FIG. 1 shows a configuration of the satellite positioning system according to a first embodiment of the present invention. In the satellite positioning system, the position of a vehicle 1 is estimated by using GNSS satellite information carried by satellite signals of a plurality of GNSS satellites (illustrating only one). The on-board unit 2 is loaded on the vehicle 1 of a user. The on-board unit 2 receives the GNSS satellite information by a GNSS antenna 6. A GNSS chip 7 of the on-board unit 2 functions as a satellite information acquiring section that acquires the satellite signals and outputs a current position of the vehicle and GNSS time data to be described later. The GNSS chip 7 estimates a three-dimensional current position of the vehicle 1 on the ground based on the received GNSS satellite information, and outputs the estimated current position as a positioning result. The on-board unit 2 further has a processing section 3 as a computer that carries out charging processing and so on by using the positioning result outputted from the GNSS chip 7.

The vehicle 1 has a battery, and supplies a vehicle power supply voltage 17 to the on-board unit 2 from the battery. The vehicle power supply voltage 17 is supplied to a power supply circuit 4 of the on-board unit 2. The vehicle 1 further outputs to the on-board unit 2, an ignition ON/OFF signal 18 showing whether an ignition key has been rotated to an ON direction to turn on an engine or to an OFF direction to turn off the engine. The ignition ON/OFF signal 18 is transmitted to the processing section 3 as an ignition ON/OFF signal 19 via the power supply circuit 4.

The processing section 3 outputs an on-board unit power supply voltage ON/OFF signal 20 to the power supply circuit 4 according to the ignition ON/OFF signal 19 showing that the ignition of the vehicle 1 has been turned on, to instruct the power supply circuit 4 of the on-board unit 2 to be turned on. The power supply circuit 4 outputs an on-board unit power supply voltage 21 based on the vehicle power supply voltage 17 supplied from the vehicle 1 in response to the on-board unit power supply voltage ON/OFF signal 20. Various circuits of the on-board unit 2 are driven with the on-board unit power supply voltage 21.

A roadside system 16 is connected with a plurality of DSRC antennas 15 (beacon) which are installed on roadsides of a road on which the vehicle runs and a parking lot. The on-board unit 2 has the DSRC antenna 10 to carry out a narrow area dedicated communication (DSRC: Dedicated Short Range Communication) with a DSRC antenna 15 bidirectionally and a DSRC communication processing section 11.

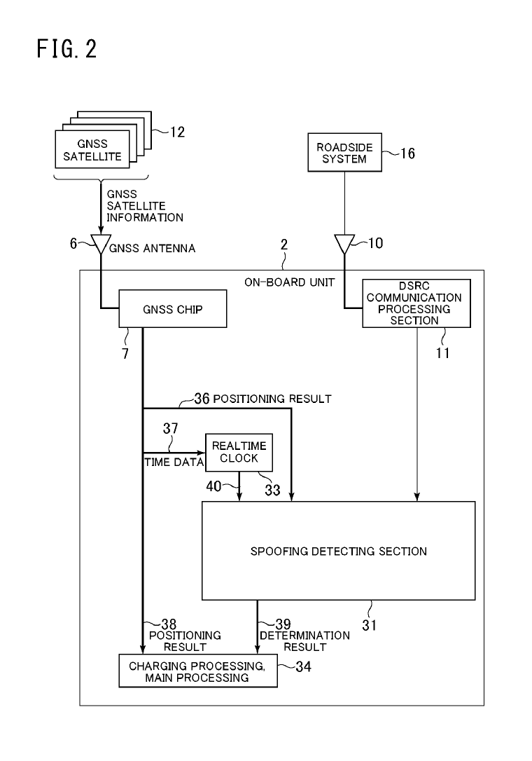

FIG. 2 shows a configuration of the on-board unit 2. The on-board unit 2 has the GNSS antenna 6, the GNSS chip 7, the DSRC antenna 10, the DSRC communication processing section 11, a realtime clock 33, a main processing section 34, and a spoofing detecting section 31. Of them, the realtime clock 33, a main processing section 34 and a spoofing detecting section 31 correspond to the processing section 3 of FIG. 1. Each of these sections which are contained in the processing section 3 may be realized in software by a program executed by a CPU and in hardware by a separate unit having a corresponding function.

A positioning result 36 outputted from the GNSS chip 7 is supplied to the spoofing detecting section 31. GNSS time data 37 showing the current time is contained in data generated by the GNSS chip 7 based on the GNSS satellite information. The GNSS chip 7 outputs the GNSS time data 37 to the realtime clock 33 of the on-board unit 2. The realtime clock 33 outputs GNSS time data 40 in the form which can be used as a time stamp and so on in the data processing and so on by the on-board unit 2 in response to the GNSS time data 37 received from the GNSS chip 7. The GNSS time data 37 outputted from the GNSS chip 7 and the GNSS time data 40 outputted from the realtime clock 33 are different in the form but have substantively identical contents.

The roadside system 16 always generates the DSRC time data showing the current time. The DSRC communication processing section 11 receives the DSRC time data through the DSRC antenna 10 and transfers to the spoofing detecting section 31.

Moreover, the positioning result 36 outputted from the GNSS chip 7 and the GNSS time data 40 outputted from the realtime clock 33 are further supplied to the spoofing detecting section 31. The spoofing detecting section 31 outputs a determination result 39 showing whether a spoofing has been carried out, based on the positioning result 36, the GNSS time data 40 and the DSRC time data. The main processing section 34 executes the charging processing when the vehicle 1 runs on a toll highway and so on, based on a positioning result 38 outputted from the GNSS chip 7 and the determination result 39 outputted from the spoofing detecting section 31.

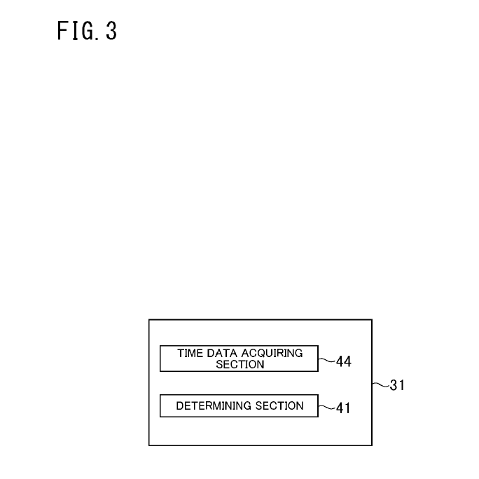

FIG. 3 shows functional blocks of the spoofing detecting section 31. The spoofing detecting section 31 in the present embodiment has a time data acquiring section 44 and a determining section 41. These functional blocks can be realized by a main CPU of the on-board unit 2 reading a program stored in a storage unit and operating according to a procedure described in the program.

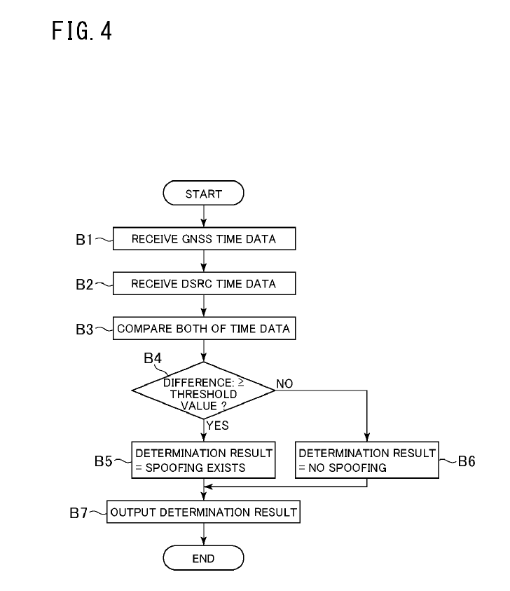

Next, an operation of the spoofing detecting section 31 in the present embodiment will be described with reference to FIG. 4. First, when the engine of the vehicle 1 is started up to turn on the on-board unit 2, the GNSS chip 7 outputs the GNSS time data 37 showing the current time based on the GNSS satellite information. The realtime clock 33 outputs the GNSS time data 40 corresponding to the GNSS time data 37 to the spoofing detecting section 31 in approximately realtime (Step B1). The time data acquiring section 44 acquires the DSRC time data from the DSRC communication processing section 11 in approximately realtime (Step B2).

The determining section 41 compares the GNSS time data 40 and the DSRC time data (Step B3). When a difference between a time shown by the GNSS time data 40 and a time shown by the DSRC time data is smaller than a given threshold value (Step B4; NO), the determining section 41 determines that any spoofing has not been carried out (Step B6). When the difference between the GNSS time data and the DSRC time data is equal to or more than the given threshold value (Step B4; YES), the determining section 41 determines that a spoofing has been carried out (Step B5).

The determining section 41 outputs a determination result 39 of the existence or non-existence of spoofing (Step B7). The main processing section 34 carries out processing such as the charging processing based on the positioning result 38, taking the determination result 39 into consideration. For example, when the spoofing is determined to have been carried out, usual charging processing is stopped and the data showing the determination result 39 is stored in the storage unit.

As one of spoofing techniques, it could be considered that the data of a past positioning result by the satellite positioning system is spoofed as if to be the current position data of the vehicle. In such a case, there is a possibility that the time data contained in data for the spoofing is different from the data of the current time. By the processing of the present embodiment, in such a case, the spoofing can be detected by comparing and verifying a time by the satellite positioning system and a time given by a radio signal which is different from the satellite signals of the satellite positioning system (the time which the roadside system 16 provides).

The spoofing detection described above has an advantage that the loading on the on-board unit 2 is easy. Below, the advantage will be described.

In the satellite positioning system, the dedicated GNSS chip is loaded on the on-board unit. It could be considered that a function of verifying the data received from the GNSS satellite is added to the GNSS chip, in order to implement the spoofing detection function. However, from the viewpoint of easiness of implementation, a technique is demanded that makes it possible to carry out the spoofing detection by using the signal outputted from the GNSS chip without changing the GNSS chip.

A standard of signals outputted from the GNSS chip is set by NMEA (National Marine Electronics Association) and so on. If the spoofing can be detected based on the output signal set to such a standard, any kind of chip can be adopted, and the degrees of freedom of the chip selection is high.

In the spoofing detection processing shown in FIG. 4, the current time outputted from the GNSS chip 7 is used as the data generated by the satellite positioning system. It has been set to the standard that the current time can be outputted from any kind of GNSS chip 7. The detailed information which the GNSS chip 7 does not always output, such as orbit information of each GNSS satellite, is not needed in the spoofing detection shown in FIG. 4. Therefore, the present embodiment has an advantage that the spoofing detection processing shown in FIG. 4 can be executed without applying any change to the GNSS chip 7, and moreover, can be executed regardless of a kind of the GNSS chip 7. Other embodiments of the present invention to be described below have such an advantage in the same way.

### Second Embodiment

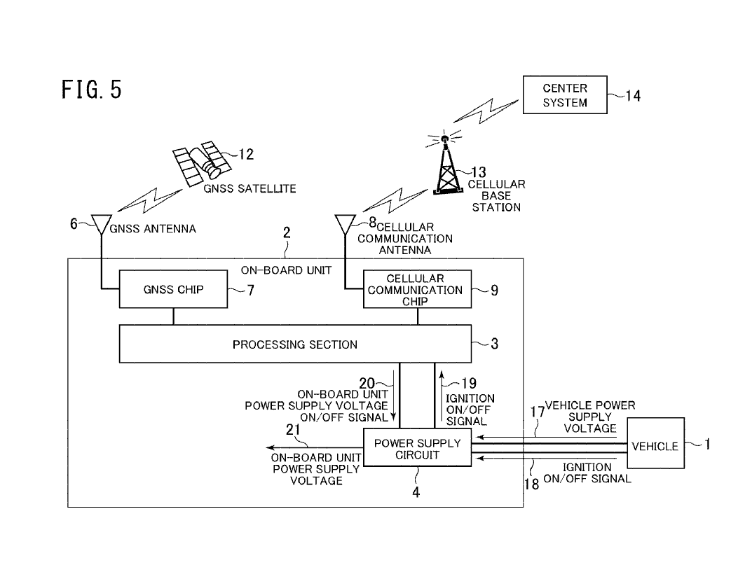

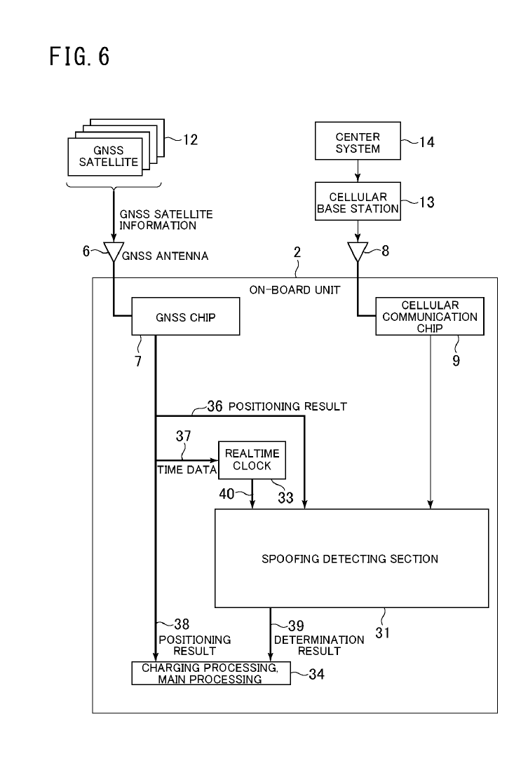

FIG. 5 shows a configuration of the satellite positioning system of a second embodiment of the present invention. FIG. 6 shows a configuration of the on-board unit 2 in the present embodiment. In the present embodiment, a cellular communication is used in place of the roadside system 16 in the first embodiment. Compared with the satellite positioning system shown in FIG. 1, the satellite positioning system in the present embodiment has a cellular communication chip 9 and a cellular communication antenna 8, and uses a cellular communication network containing a center system 14 and cellular base stations 13.

The cellular communication is a technique used generally as one of the techniques of a mobile communication. An outline will be described below. In the cellular communication, a communication area is divided into many small cells and a base station is installed in each cell. The size of the cell is in a range from several kilometers to ten and several kilometers, centered on the base station. A technique may be used in which the communication area is divided into micro cells which are smaller than the cell. The output of radio wave of each base station is an extent to cover the cell which the base station belongs, as the communication area. That is, each base station is installed apart from another base station so as not to cause radio wave interference. Therefore, the same frequency can be used among the different base stations and it is possible to use the frequency effectively.

The cellular communication network can be used as a part of the charging processing system which uses a position estimation result of the vehicle 1 by the GNSS. The GNSS chip 7 estimates and outputs the position of the vehicle 1 as the positioning result, based on the GNSS satellite information received from the GNSS satellite 12. The cellular communication chip 9 transmits the positioning result from the cellular communication antenna 8. The positioning result is transmitted to center system 14 through the cellular base station 13 near the vehicle 1. By the bidirectional communication between the on-board unit 2 and the cellular communication network, the processing such as the charging processing using the positioning result of the vehicle 1 is carried out.

The cellular communication network uses the cellular communication time data showing the current time. In the present embodiment, the cellular communication time data is transmitted to the on-board unit 2 from the cellular base station 13. The cellular communication chip 9 transfers the cellular communication time data received through the cellular communication antenna 8 to the spoofing detecting section 31 in approximately realtime.

In the present embodiment, the spoofing detecting section 31 detects the spoofing by using the cellular communication time data in place of the DSRC time data in case of the operation of the first embodiment shown in FIG. 4. In such a satellite positioning system, the spoofing can be detected even in an area where the DSRC roadside unit is not installed.

### Third Embodiment

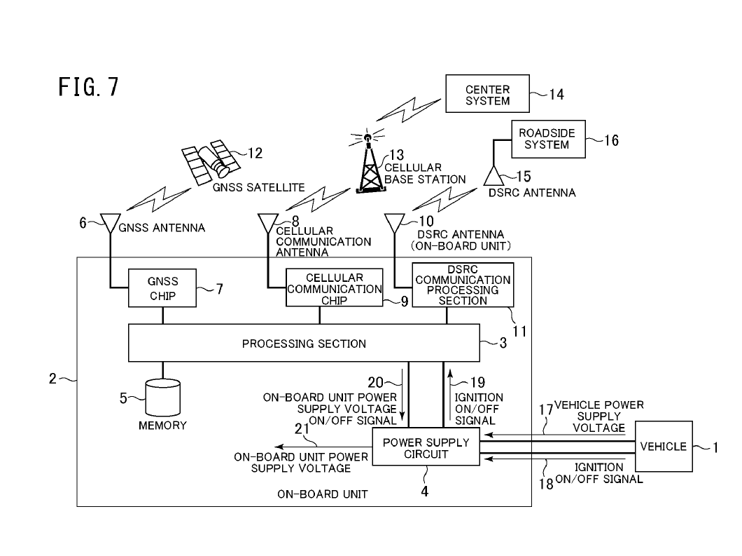

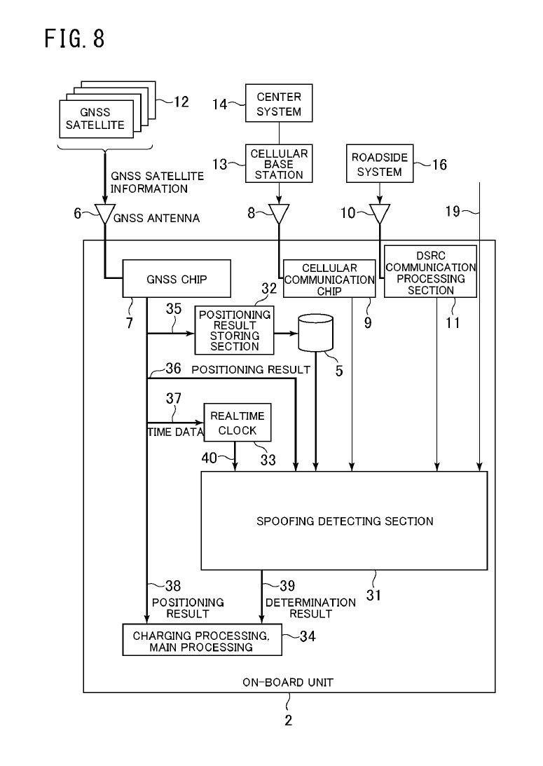

Next, a third embodiment of the present invention will be described. FIG. 7 shows a configuration of the satellite positioning system in the third embodiment. FIG. 8 shows a configuration of the on-board unit 2 of the present embodiment. In the present embodiment, the following processing is carried out:

(1) the spoofing detection based on the past and current GNSS positioning results;

(2) the spoofing detection based on a comparison between the GNSS time data and the DSRC time data or a comparison between the GNSS time data and the cellular communication time data; and

(3) the spoofing detection based on a comparison of the GNSS positioning result and the position of the DSRC roadside unit or a comparison of the GNSS positioning result and the communication area of the cellular base station.

Of them, in the processing (2), the processing shown in the first embodiment or the second embodiment is carried out. In the present embodiment, the processing of (1) and (3) is further added.

### (Record of Past Positioning Result)

In the on-board unit 2 in the present embodiment, the processing section 3 stores the positioning result which is based on the GNSS satellite information, in the positioning result storage area 5 provided in the storage unit, together with a positioning time showing a time when the positioning was carried out. When the GNSS chip 7 outputs the positioning result 35, the positioning result storing section 32 stores the positioning result 35 in the positioning result storage area 5 with the current time. The positioning result 35 is stored in the positioning result storage area 5 in relation to the positioning time.

### (Acquisition of Position Data by DSRC)

The roadside system 16 transmits DSRC position data showing the position of the DSRC antenna (roadside unit). The DSRC communication processing section 11 transfers the DSRC position data received by the DSRC antenna 10 to the spoofing detecting section 31 as the DSRC positioning result.

### (Configuration of Spoofing Detecting Section)

The spoofing detecting section 31 outputs a determination result 39 showing whether a spoofing has been carried out, based on the past positioning result 35 and the positioning time stored in the positioning result storage area 5, the positioning result 36 (the GNSS positioning result) outputted from the GNSS chip 7, and the DSRC positioning result. The main processing section 34 executes the charging processing and so on when the vehicle 1 runs on a toll highway, based on the positioning result 38 outputted from the GNSS chip 7 and the determination result 39 outputted from the spoofing detecting section 31.

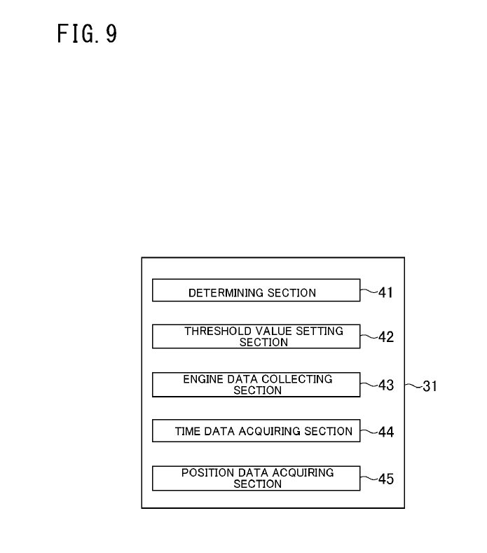

FIG. 9 shows functional blocks of the spoofing detecting section 31. The spoofing detecting section 31 in the present embodiment has a threshold value setting section 42, an engine data collecting section 43 and a position data acquiring section 45, in addition to the configuration of the first embodiment shown in FIG. 3. These functional blocks can be realized by the main CPU of the on-board unit 2 which reads a program stored in the storage unit, and operates according to a procedure written in the program.

### (Operation of Spoofing Detecting Section Using Past and Current GNSS Positioning Results)

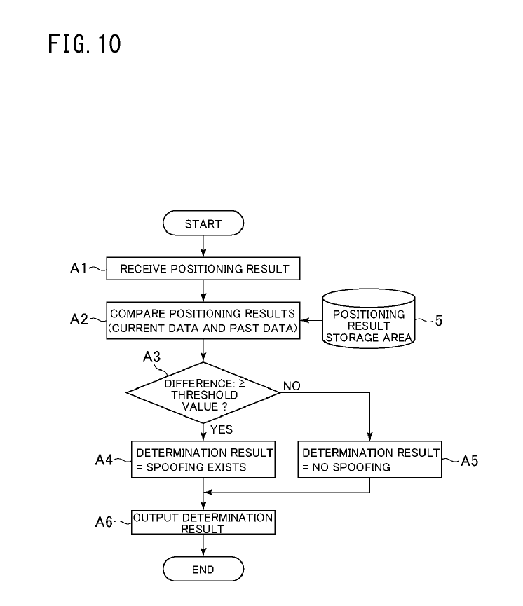

Next, the operation of the spoofing detecting section 31 in the present embodiment will be described. In the present embodiment, the spoofing detecting section 31 carries out the spoofing detection (the previously mentioned processing (1)) based on the past and current GNSS positioning results. FIG. 10 is a flow chart showing the operation of the spoofing detecting section 31 in case of the spoofing detection based on the past and current GNSS positioning results in the present embodiment.

When the engine of the vehicle 1 is started up to turn on the on-board unit 2, the GNSS chip 7 outputs the positioning results 35, 36, and 38 which are data showing a three-dimensional position of the vehicle 1 on the ground based on the GNSS satellite information. The positioning result storing section 35 stores the positioning result 35 in the positioning result storage area 5 together with the positioning time showing the current time (Step A1).

The determining section 41 compares the current positioning result 36 outputted from the GNSS chip 7 and the past positioning result stored in the positioning result storage area 5. For example, this comparison is executed by previously setting a time difference quantity, reading the past positioning result before by the set time difference quantity (e.g. before 10 seconds) from the positioning result storage area 5, and comparing the current positioning result 36 with the read past positioning result (Step A2).

The determining section 41 compares a difference between the past positioning result and the current positioning result and a previously set threshold value to determine which of them is more. As the threshold value, a distance is set that seems to be unnatural for the vehicle 1 to move for the set time difference quantity used at step A2. For example, if the time difference quantity is set to 10 seconds and the threshold value is set to 500 meters, it is determined to be unnatural movement when a distance between the positioning result before 10 seconds and the current positioning result is equal to or more than 500 meters.

When the difference is not equal to or more than the threshold value (Step A3; NO), the determining section 41 determines that any spoofing has not been carried out and the positioning is normally carried out (Step A5). When the difference is equal to or more than the threshold value (Step A3; YES), the determining section 41 determines that a spoofing has been carried out (Step A4).

The determining section 41 outputs the determination result 39 of the existence or non-existence of spoofing (Step A6). The main processing section 34 carries out processing such as the charging processing based on the positioning result 38, taking the determination result 39 into consideration. For example, when the spoofing is determined to have been carried out, usual charging processing is stopped and the data showing the determination result 39 is stored in the storage unit.

By the above processing, when the positioning result based on the GNSS satellite information shows an unnatural leap as the result of a spoofing, the charging processing depending on spoofing data can be avoided.

In addition to the above spoofing detection processing, means for identifying a positioning error due to a multipath and so on may be provided in the satellite positioning system. In case of the positioning error due to the multipath, for example, the running route of the vehicle based on the satellite positioning shows a temporarily unnatural leap and returns to an original correct positioning result again. Therefore, when a period for which a distance difference determined at step A3 is equal to or more than the threshold value is equal to or shorter than a given period, the processing may be carried out in which a spoofing is determined not to have been carried out by determining that there is a possibility of the positioning error due to the multipath and so on.

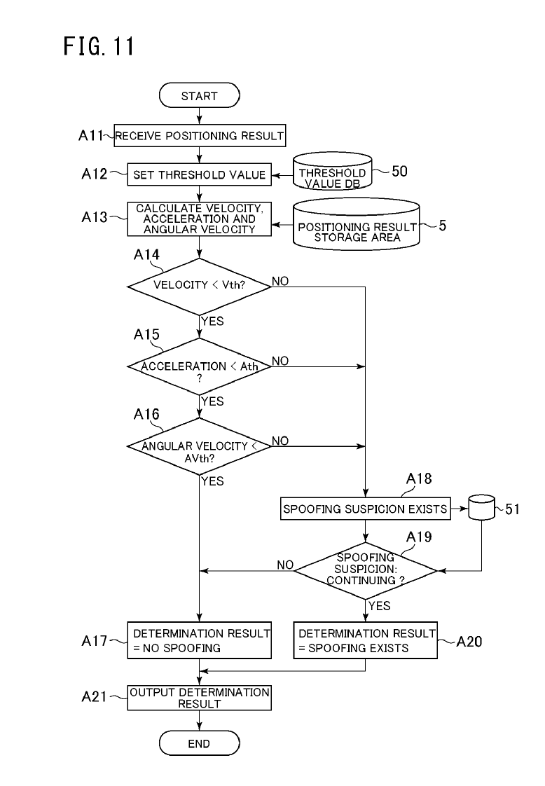

In addition to the above-mentioned processing shown in FIG. 10, the spoofing determining process can be carried moreover out by the operation of the threshold value setting section 42. FIG. 11 is a flow chart showing such an operation of the spoofing detecting section 31. The GNSS chip 7 outputs the positioning results 35, 36, and 38 like the step A1 of FIG. 10. The positioning result storing section 32 stores the positioning result 35 in the positioning result storage area 5, together with the positioning time showing the current time (Step A11).

Next, the threshold value setting section 42 refers to the threshold value database 50 stored in the storage unit of the on-board unit 2 and sets a threshold value. For example, the position change of the vehicle 1 is fast while the vehicle 1 runs on a highway, and is late while the vehicle 1 runs in a built-up area. Therefore, by setting a different threshold value of the running speed according to the current position of the vehicle 1, it is possible to determine whether time series changes of the positioning results 35, 36, 38 of the vehicle 1 are unnatural.

In order to carry out such a determination, the threshold value database 50 stores an area on a map and a threshold value in relation to each other. For example, a large speed threshold value is set to the area showing a highway, and a small speed threshold value is set to the area showing a built-up area. The threshold value setting section 42 extracts the threshold value corresponding to the current position of the vehicle 1 which is shown by the positioning result 36 outputted from the GNSS chip 7, from the threshold value database 50, and sets as the threshold value for the spoofing detection. For example, such a threshold value can be set for each of speed, acceleration, angular speed and so on of the vehicle (Step A12).

The determining section 41 calculates the current speed, the current acceleration, and the current angular speed of the vehicle 1 based on the positioning result 36 supplied from the GNSS chip 7 and a record of past positioning result and positioning time stored in the positioning result storage area 5 (Step A13).

The determining section 41 compares the calculated speed of the vehicle 1 and the threshold value Vth of the speed set by the threshold value setting section 42 and determines which of them is more. When the speed of the vehicle 1 is smaller than the threshold value (Step A14; YES), the control advances to the processing of step A15. When the speed of the vehicle 1 is equal to or more than the threshold value (Step A14; NO), it is determined that there is a suspicion that a spoofing has been carried out (Step A18).

The determining section 41 compares the calculated acceleration of the vehicle 1 and a threshold value Ath of the acceleration set by the threshold value setting section 42 and determines which of them is more. When the acceleration of the vehicle 1 is smaller than the threshold value (Step A15; YES), the control advances to the processing of step A16. When the acceleration of the vehicle 1 is equal to or more than than the threshold value (Step A15; NO), it is determined that there is a suspicion that a spoofing has been carried out (Step A18).

The determining section 41 the calculated angular speed of the vehicle 1 and the threshold value Ath of the angular speed set by the threshold value setting section 42 and determines which of them is more. When the angular speed of the vehicle 1 is smaller than the threshold value (Step A16; YES), the control advances to the processing of step A17. When the angular speed of the vehicle 1 is equal to or more than the threshold value (Step A16; NO), it is determined that there is a suspicion that a spoofing has been carried out (Step A18). By this processing, when a change rate of the direction of the vehicle is large unnaturally, it is possible to determine that there is a spoofing suspicion.

The steps A14 to A16 may be executed in an optionally order, and only one or two kinds of processing corresponding to the above steps may be executed. In the above processing, a spoofing is determined not to have been carried out when the quantity showing the movement of the vehicle (speed, acceleration, angular speed) falls below the threshold value (Step A17).

When a spoofing suspicion is determined to exist, a record of spoofing suspicion is registered on the spoofing candidacy database 51 in relation to the current time outputted from the GNSS chip 7 at step A18.

When the spoofing suspicion has occurred, the determining section 41 extracts a record of past spoofing suspicion from the spoofing candidacy database 51. When a period for which the spoofing suspicion continues is shorter than a given threshold value (Step A19; NO), the spoofing is determined not to have been carried out because it is a short-range positioning error due to a multipath and so on (Step A17). When the period for which the spoofing suspicion continues is equal to or longer than the threshold value (Step A19; YES), the spoofing is determined to have been carried out (Step A20).

The determining section 41 outputs the determination result 39 showing the the non-existence of spoofing generated at step A17 or the existence of spoofing generated at step A20 (Step A21). The main processing section 34 takes the determination result 39 into consideration when the charging processing and so on re executed based on the positioning result 38 outputted from the GNSS chip 7, like the first embodiment.

### (Spoofing Determination by Using Start-Up Condition of Engine)

In addition to the above processing, a spoofing determination using the operation of the engine data collecting section 43 of FIG. 9 may be added. Generally, when the engine of the vehicle 1 is in a stop condition, the position of the vehicle 1 does not change. When the position of the vehicle 1 estimated by the satellite positioning system changes over an extent of distance when the engine of the vehicle 1 is in the stop condition, it could be considered that the spoofing suspicion exists.

In order to detect such a spoofing suspicion, the engine data collecting section 43 monitors the ignition ON/OFF signal 19. When the engine of the vehicle 1 is determined to have been stopped (an ignition key is set to an off state) based on the ignition ON/OFF signal 19, the engine data collecting section 43 stores the last positioning result 36 outputted previously from the GNSS chip 7 in the storage unit of the on-board unit 2, as the positioning result in the engine stop condition.

When the engine data collecting section 43 recognizes that the ignition ON/OFF signal 19 has changed from the off condition to the on condition, the first positioning result 36 outputted from the GNSS chip 7 is transferred to the determining section 41 as the positioning result at the time of engine start-up, together with a positioning result in the engine stop condition. The determining section 41 calculates a difference between the positioning result in the engine stop condition and the positioning result in the engine start-up condition. The determining section 41 determines to be normal, when the difference is smaller than a given threshold value, and a spoofing is determined to have been carried out when the difference is equal to or longer than the threshold value.

### (Operation of Spoofing Detecting Section Using DSRC Position Data)

In the present embodiment, the spoofing detecting section 31 moreover carries out the spoofing detection (the processing (3)) based on a comparison of the GNSS positioning result and the position of the the DSRC roadside unit. FIG. 10 is a flow chart showing an operation of the spoofing detecting section 31 in case of the spoofing detection based on the comparison of the GNSS positioning result and the position of the DSRC roadside unit in the present embodiment.

First, when the engine of the vehicle 1 is started up to turn on the on-board unit 2, the GNSS chip 7 outputs the positioning results 36 and 38 which are data showing a three-dimensional position of the vehicle 1 on the ground based on the GNSS satellite information (Step C1). The position data acquiring section 45 receives the DSRC positioning result from the DSRC communication processing section 11 in approximately realtime (Step C2).

The determining section 41 compares the current positioning result 36 outputted from the GNSS chip 7 (the GNSS positioning result) and the DSRC positioning result (position data) (Step C3). The determining section 41 compares a difference between (a distance between both of) the position shown by the GNSS positioning result and the position shown by the DSRC positioning result and a previously set threshold value and determines which of them is more. As this threshold value, a distance which is equal to or more than a communication area of the DSRC roadside unit is set. When the difference is smaller than the threshold value (step C4; NO), the determining section 41 advances to the processing of step C5. When the difference is equal to or more than the threshold value (step C4; YES), the determining section 41 advances to the processing of step C6.

When the determination of “YES” is accomplished at step C4, the determining section 41 determines the existence of a spoofing suspicion (Step C6). When the spoofing suspicion is determined to exist, a record of spoofing suspicion is registered on the spoofing candidacy database 51 in relation to the current time.

When the spoofing suspicion has occurred, the determining section 41 extracts a record of past spoofing suspicion from the spoofing candidacy database 51. When a period for which the spoofing suspicion continues is shorter than a given threshold value (Step C7; NO), a spoofing is determined not to have been carried out (Step C5) because it is a short-range positioning error due to the multipath and so on. When the period for which the spoofing suspicion continues is equal to or more than the given threshold value (Step C7; YES), the spoofing is determined to have been carried out (Step C8).

The determining section 41 outputs a determination result showing the non-existence of spoofing generated at step C5 or the existence of spoofing generated at step C8 (Step C9). The main processing section 34 takes the determination result 39 into consideration, when executing the charging processing and so on based on the positioning result 38 outputted from the GNSS chip 7. For example, when the spoofing is determined to have been carried out, the main processing section 34 stops the usual charging processing, and stores the data showing the determination result 39 in the storage unit.

By the above processing, the spoofing can be detected when the positioning result based on the GNSS satellite information is unnaturally apart from the position of the communicating DSRC roadside unit as the result of the spoofing.

### (Operation of Spoofing Detecting Section Using Cellular Base Station Position Data)

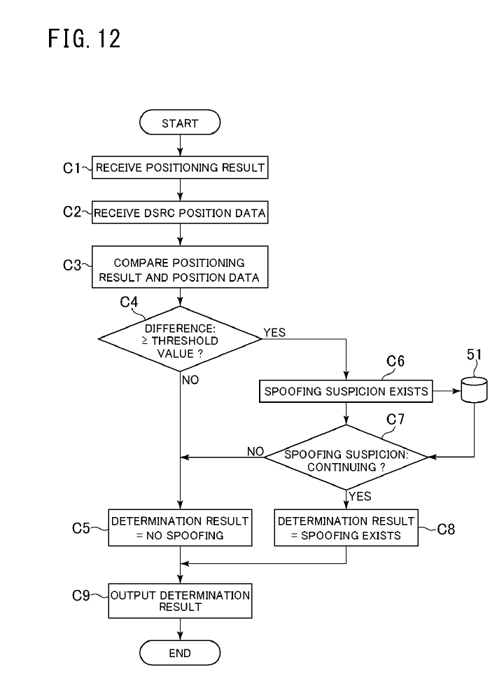

The spoofing can be detected based on the position (the communication area) of the cellular base station 13 in place of the DSRC position data shown in FIG. 12. The cellular communication network transmits an identifier for specifying of the cellular base station 13 communicating with the on-board unit 2 to the on-board unit 2 when communication for the charging processing and so on with the on-board unit 2 through the cellular base station 13 is carried out. The position of the vehicle 1 is recognized roughly based on the identifier, and it is possible to use the position instead of the DSRC positioning result in the first embodiment.

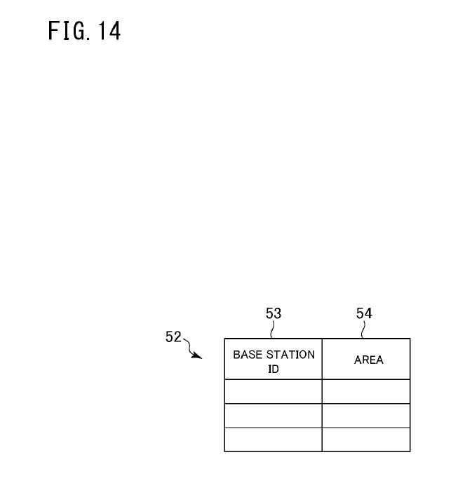

FIG. 14 shows a base station ID table 52 which is previously registered on the spoofing detecting section 31 in the present embodiment. The base station ID table 52 relates the base station ID 53 which is an identifier for specifying each of the plurality of base stations and an area 54 which is the data showing the communication area covered by each cellular base station 13.

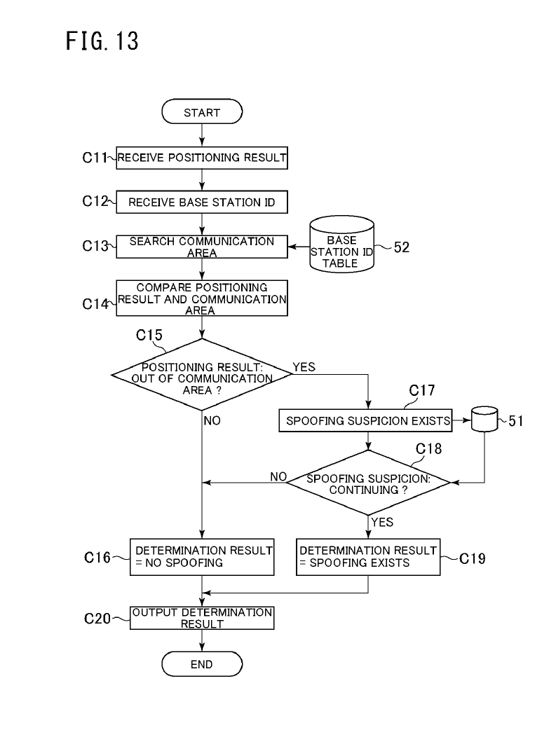

FIG. 13 shows an operation of the spoofing detecting section 31 in the present embodiment. Like the step C1 of FIG. 12, the positioning result 36 by the satellite positioning system is supplied to the spoofing detecting section 31 (Step C11). The cellular communication chip 9 extracts the base station ID 53 which specifies the communicating cellular base station 13 from among the signals received from the cellular base station 13 through the cellular communication antenna 8. A position data acquiring section 45 receives the base station ID 53 from the cellular communication chip 9 (Step C12). The position data acquiring section 45 searches the area 54 corresponding to the base station ID 53 acquired from the cellular communication chip 9 from the base station ID table 52 (Step C13).

The determining section 41 compares the position shown by the GNSS positioning result and the area 54 (the cellular base station communication area) searched from base station ID table 52 (Step C14). The determining section 41 advances to the processing of step C16, when the GNSS positioning result is in the cellular base station communication area (Step C15; NO), and advances to the processing of step C17 when it is not in the area (step C15; YES). The processing of the following steps C16 to C20 is the same as that of the steps C5 to C9 of FIG. 12.

In the present embodiment, the spoofing detecting section 31 detects the spoofing by using the position of communicating cellular base station 13 in place of the DSRC positioning result in the operation shown in FIG. 12. In such a satellite positioning system, the spoofing can be detected even in the area where the DSRC roadside unit is not installed.

The following three spoofing detection results are obtained, by the spoofing detecting section 31 carrying out the processing shown in FIG. 10 or FIG. 11 and the processing shown in FIG. 12 or FIG. 13, in addition to the processing shown in FIG. 4:

(1) the spoofing detection based on the past and current GNSS positioning results;

(2) the spoofing detection based on the comparison with the GNSS time and the DSRC time (or the cellular communication time); and

(3) the spoofing detection based on the comparison of the GNSS positioning result and the position of the the DSRC roadside unit (or, the communication area of the cellular base station).

When “the existence of spoofing” is determined in at least one of these three types of spoofing detecting methods, the spoofing detecting section 31 outputs the determination result 39 showing the existence of spoofing, considering as a whole. Or, when “the existence of spoofing” is determined in at least two of the three types of spoofing detecting method, the spoofing detecting section 31 may adopt a majority vote method which outputs the determination result 39 showing the existence of spoofing, considering as a whole. Or, in addition to the (2) method which is the same as in the first embodiment, either of (1) method and (3) method may be adopted. In this case, when the spoofing is detected in at least one of the two spoofing detection methods, the spoofing detecting section 31 outputs the determination result 39 showing the existence of spoofing, considering as a whole. Or, when the spoofing is detected in both methods, the spoofing detecting section 31 may output the determination result 39 showing the existence of spoofing, considering as a whole.

1. An on-board unit comprising:
a satellite information acquiring section configured to output first time data showing a current time based on a satellite signal received from an artificial satellite; and
a processing section configured to acquire second time data showing a current time based on a radio signal which is different from the satellite signal, and detects a spoofing based on a difference between a time shown by the first time data and a time shown by the second time data.

2. The on-board unit according to claim 1, wherein the processing section determines that the spoofing has been carried out, when the difference between the time shown by the first time data and the time shown by the second time data is equal to or more than a threshold value.

3. The on-board unit according to claim 1, wherein the processing section acquires the second time data from a roadside unit which is provided on a side of a road on which the vehicle runs.

4. The on-board unit according to claim 1, wherein the processing section acquires the second time data through a cellular communication.

5. A spoofing detecting method of an on-board unit, comprising:
outputting first time data showing a current time based on a satellite signal received from an artificial satellite;
acquiring second time data showing a current time by a radio signal which is different from the satellite signal; and
detecting a spoofing based on a difference between a time shown by the first time data and a time shown by the second time data.

6. The spoofing detecting method of the on-board unit according to claim 5, wherein the detecting a spoofing comprises:
determining that the spoofing has been carried out, when the difference between the time shown by the first time data and the time shown by the second time data is equal to or more than the threshold value.

7. The spoofing detecting method of the on-board unit according to claim 5, wherein the second time data is acquired from a roadside unit which is provided on a side of a road on which the vehicle runs.

8. The spoofing detecting method of the on-board unit according to claim 5, wherein the second time data is acquired by a cellular communication.
